(19) United States
(12) Patent Application Publication
(10) Pub. No.: US 2017/0023367 A1
(43) Pub. Date: Jan. 26, 2017

(54) CURFEW VIOLATION NOTIFICATION APPARATUS AND METHOD

(71) Applicant: HYUNDAI MOTOR COMPANY, Seoul (KR)

(72) Inventor: Geum Dan JIN, Seoul (KR)

(21) Appl. No.: 14/945,356

(22) Filed: Nov. 18, 2015

(30) Foreign Application Priority Data
Jul. 23, 2015 (KR) 10-2015-0104187

(51) Int. Cl. G01C 21/20; G08G 1/123; G01C 21/36

(52) U.S. Cl. CPC G01C 21/20; G01C 21/3691; G08G 1/123

(57) ABSTRACT

A curfew violation notification method includes inputting a destination to a navigation system of a vehicle, detecting a plurality of routes from a current location of the vehicle to the destination, calculating an estimated time of arrival (ETA) of each route, determining whether the ETA of a first route selected among the plurality of routes is within a preset curfew period, and sending a notification message to a preset device if the ETA of the first route is within the curfew period. Accordingly, a driver may preliminarily recognize curfew violation to occur while driving, sudden curfew violation notifications while driving may be effectively reduced, and the possibility of distraction may be reduced.

### CROSS-REFERENCE TO RELATED APPLICATION

This application claims the benefit of priority to Korean Patent Application No. 10-2015-0104187, filed on Jul. 23, 2015, which is hereby incorporated by reference as if fully set forth herein.

### TECHNICAL FIELD

The present disclosure relates to an apparatus and method for calculating an estimated time of arrival (ETA) at a destination using a navigation system and preliminarily issuing a warning before starting to drive if the ETA violates a preset curfew period and, more particularly, to a curfew violation notification apparatus and method capable of effectively reducing the possibility of distraction of a driver while driving by preliminarily issuing a curfew violation notification after the navigation system detects routes and before the driver starts to drive.

### BACKGROUND

Due to development of technologies, a navigation system currently has various functions such as DMB broadcast reception, video playback, MP3 playback, and gaming as well as its original function of detecting a route to a destination.

In particular, the shortest route may be detected depending on real-time traffic information using a device exclusively for Transport Protocol Expert Group (TPEG) corresponding to a standard technology for receiving traffic information using a DMB broadcast network.

Meanwhile, a curfew function among various functions of the navigation system is a function for setting a driving enabled or disabled period and issuing a notification to a registered device using a short message service (SMS) or an e-mail if a vehicle is driven during the driving disabled period.

When the curfew function of the navigation system is enabled, a setter of a curfew period is generally different from a driver. Accordingly, the driver may not easily recognize curfew violation before the curfew period is additionally checked.

This situation causes a warning to be issued to the driver while driving, and thus the possibility of distraction while driving may be increased.

Currently, the number of traffic accidents occurring due to distraction of drivers while driving is increased every year because the drivers look away from the road and thus cannot rapidly react to a situation on the road.

In relation to this, a curfew violation warning may also increase the possibility of distraction and the possibility of using a communication device while driving, and thus a time for reacting to an emergency may be lost. As such, a method and apparatus for preliminarily issuing a curfew violation warning to a driver are necessary.

### SUMMARY

Accordingly, the present disclosure is directed to a curfew violation notification apparatus and method that substantially obviates one or more problems due to limitations and disadvantages of the related art.

An object of the present disclosure is to provide a curfew violation notification apparatus and method capable of reducing the possibility of distraction by preliminarily providing a notification using a curfew function of a navigation system after the navigation system detects a route and before a driver starts to drive and, more particularly, a curfew violation notification apparatus and method capable of preliminarily issuing a notification to a driver if an estimated time of arrival (ETA) at a destination is within a curfew period.

Another object of the present disclosure is to provide a curfew violation notification apparatus and method capable of graphically issuing a curfew violation warning flexibly depending on a traffic condition in addition to an ETA at a destination.

A further object of the present disclosure is to provide a curfew violation notification apparatus and method capable of preliminarily issuing a curfew violation notification based on a time obtained by adding a preset value, e.g., a violation possibility time, to a calculated ETA.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a curfew violation notification method includes inputting a destination to a navigation system of a vehicle, detecting a plurality of routes from a current location of the vehicle to the destination, calculating an estimated time of arrival (ETA) of each route, determining whether the ETA of a first route selected among the plurality of routes is within a preset curfew period, and sending a notification message to a preset device if the ETA of the first route is within the curfew period.

In another aspect of the present disclosure, a curfew violation notification control apparatus includes a driving route detection module for detecting a plurality of routes from a current location of a vehicle to a destination, an estimated time of arrival (ETA) calculation module for calculating an ETA of each route, a curfew violation determination module for determining whether the ETA of a first route selected among the plurality of routes is within a preset curfew period, and a communication module for sending a notification message to a preset device if the ETA of the first route is within the curfew period.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart of a curfew violation notification method according to an embodiment of the present invention;

FIG. 2 is a structural view of a curfew violation notification system according to an embodiment of the present invention;

FIG. 3 is a structural view of a curfew violation notification apparatus according to an embodiment of the present invention;

FIG. 4 is a flowchart related to an output interface of the curfew violation notification apparatus, according to an embodiment of the present invention; and

FIG. 5 is a flowchart related to an output interface of the curfew violation notification apparatus, according to another embodiment of the present invention.

### DETAILED DESCRIPTION OF THE INVENTION

Reference will now be made in detail to the preferred embodiments of the present invention, examples of which are illustrated in the accompanying drawings. Like reference numerals in the drawings denote like elements and repeated descriptions thereof will be omitted. The suffixes “module”, “---er/or” and “unit” of elements herein are used for convenience of description and thus can be used interchangeably and do not have any distinguishable meanings or functions.

In the following description of the present invention, a detailed description of known functions and configurations incorporated herein will be omitted when it may make the subject matter of the present invention unclear.

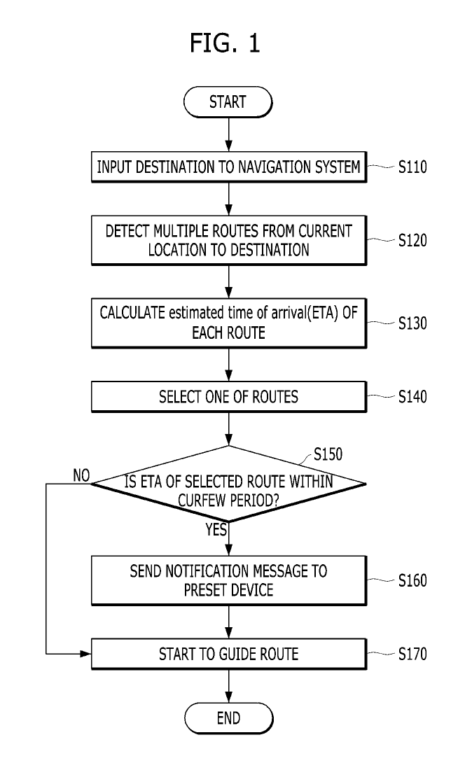

FIG. 1 is a flowchart of a curfew violation notification method according to an embodiment of the present invention.

In curfew violation notification, a setter is generally different from a driver, and a curfew function needs to be preliminarily set. A curfew period should be set in a navigation system directly by the setter or by a seller of the navigation system.

In addition, a mobile phone number or an e-mail address should be preliminarily set as information about a preset device to which a message is sent when the curfew period is violated.

If the driver inputs a destination to the navigation system before starting to drive (S110), the navigation system checks a current location of a vehicle by receiving a signal from a global positioning system (GPS) satellite using a GPS module of the vehicle.

After the current location of the vehicle is checked, the navigation system detects a plurality of routes to the input destination (S120). Real-time traffic information received from a navigation server may be used to detect the routes.

The navigation system calculates an estimated time of arrival (ETA) of each of the detected routes (S130). The real-time traffic information received from the navigation server may also be used to calculate the ETA.

The driver may manually select one of the routes, or a route having the earliest ETA may be automatically selected (S140).

The navigation system determines whether the ETA of the selected route is within a preset curfew period (S150), and starts to guide the route (S170) upon determining that the ETA of the selected route is not within the curfew period (“NO” of S150).

Upon determining that the ETA of the selected route is within the curfew period (“YES” of S150), the navigation system sends a notification message to a preset device (S160).

By preliminarily sending the notification message before starting to drive when a route of the navigation system is selected, the driver may not receive a warning while driving and may not experience distraction due to the warning.

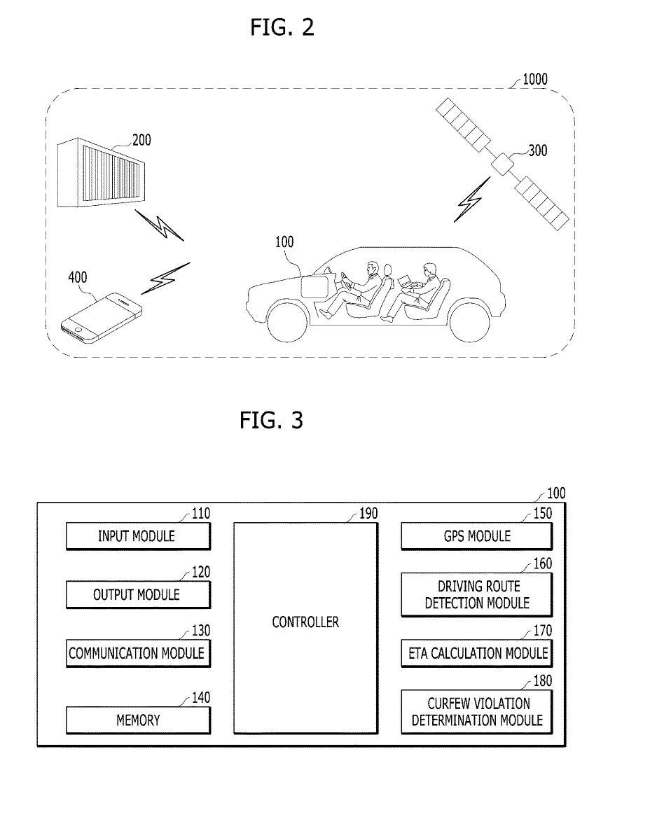

FIG. 2 is a structural view of a curfew violation notification system 100 according to an embodiment of the present invention.

Referring to FIG. 2, the curfew violation notification system 1000 includes a curfew violation notification apparatus 100, a navigation server 200, a GPS satellite 300, and a device 400.

In FIG. 2, if a driver inputs a destination, the curfew violation notification apparatus 100 checks a current location of a vehicle by exchanging signals with the GPS satellite 300.

The curfew violation notification apparatus 100 detects routes and calculates estimated times of arrival to the destination using location information. The routes may be detected and the estimated times of arrival may be calculated in consideration of real-time traffic information received from the navigation server 200 through communication.

If the ETA of a selected route is within a curfew period, the curfew violation notification apparatus 100 sends a curfew violation message to the preset device 400 using a short message service (SMS) or an e-mail.

The navigation server 200 may detect, extract, analyze, and transmit information about the routes from the current location of the vehicle to the destination in real-time traffic information received from a web server, and thus provide the information required by the curfew violation notification apparatus 100 to detect the routes and calculate the estimated times of arrival.

FIG. 3 is a structural view of the curfew violation notification apparatus 100 according to an embodiment of the present invention.

Referring to FIG. 3, the curfew violation notification apparatus 100 may include an input module 110, an output module 120, a communication module 130, a memory 140, a GPS module 150, a driving route detection module 160, an ETA calculation module 170, a curfew violation determination module 180, and a controller 190.

The elements illustrated in FIG. 3 are not essential, and thus the curfew violation notification apparatus 100 may include a larger or smaller number of elements.

A detailed description is now given of each element.

The input module 110 serves to input various types of information and/or signals to be processed by the controller 190 to provide a curfew violation notification, for example, using a touchscreen or key buttons, or in the form of sound through voice recognition.

The output module 120 serves to output various types of information and/or signals processed by the controller 190 to provide the curfew violation notification, for example, using a display or a speaker.

The communication module 130 serves provide a wireless communication means for a mobile communication network capable of bidirectional wireless data communication, and provides real-time information and/or a data communication function while the curfew violation notification apparatus 100 is in motion.

The memory 140 integrally refers to a space and/or region for storing certain program code for controlling overall operation of the curfew violation notification apparatus 100 and data which is input and output when operation is performed by executing the program code, and is provided in the form of electrically erasable and programmable read only memory (EEPROM), flash memory (FM), a hard disk drive, or the like.

The memory 140 may store navigation content, e.g., a map, for providing navigation services via the curfew violation notification apparatus 100. The memory 140 may also store information about the contents of a message to be transmitted to the preset device 400 when an ETA is within a curfew period.

The GPS module 150 wirelessly calculates a current location of a vehicle using a GPS satellite to provide location-based navigation services.

By periodically performing a process of calculating the location of the vehicle and generating location information, routes may be detected in consideration of real-time traffic information.

The driving route detection module 160 may receive the current location information of the vehicle from the GPS module 150, and detect a route to a destination using the map information of the memory 140. The driving route detection module 160 may receive real-time traffic information from the navigation server 200 and detect the route in consideration of the real-time traffic information. The driving route detection module 160 may detect a plurality of available routes to the destination.

The ETA calculation module 170 may calculate an ETA of each of the routes to the destination in consideration of the real-time traffic information received from the navigation server 200, or in consideration of vehicle driving state information received from the controller 190.

The curfew violation determination module 180 determines whether the ETA is within a preset curfew period.

The controller 190 is associated with an electronic control unit (ECU) (not shown) of the vehicle, collects various information items related to the vehicle, e.g., current vehicle speed, engine revolutions per minute (RPM), fuel gauge, and engine temperature, from the ECU, and provides the same to corresponding modules.

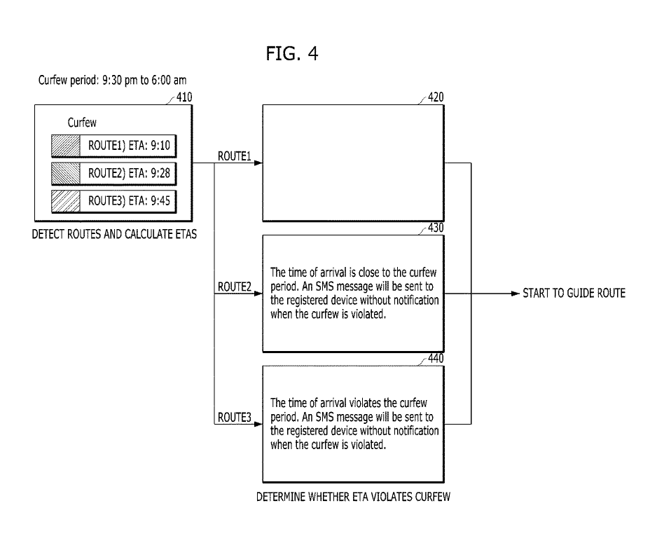

FIG. 4 is a flowchart related to an output interface of the curfew violation notification apparatus 100, according to an embodiment of the present invention.

Referring to FIG. 4, a curfew period is preliminarily set to a period, for example, from 9:30 pm to 6:00 am.

If a driver inputs a destination, the output module 120 of the curfew violation notification apparatus 100 may output an ETA of each of a plurality of detected routes using a display or a speaker (410).

A route may be selected by the driver or a route having the shortest distance or the earliest ETA may be automatically selected among the detected routes.

If the driver selects “route1” (420), since the ETA thereof is not within the curfew period, the ETA calculation module 170 starts to guide the route without transmitting any warning message to a predetermined device.

If the driver selects “route2” (430), since the ETA thereof is not within the curfew period but a time difference therebetween is not large, a message such as “The time of arrival is close to the curfew period. An SMS message will be sent to the registered device without notification when the curfew is violated.” may be displayed.

As in “route2”, if the ETA thereof is not within the curfew period but a time difference therebetween is less than a preset time interval (e.g., 10 minutes), a warning message may be sent to the preset device 400.

If the driver selects “route3” (440), since the ETA thereof is within the curfew period, a message such as “The time of arrival violates the curfew period. An SMS message will be sent to the registered device without notification when the curfew is violated.” may be displayed.

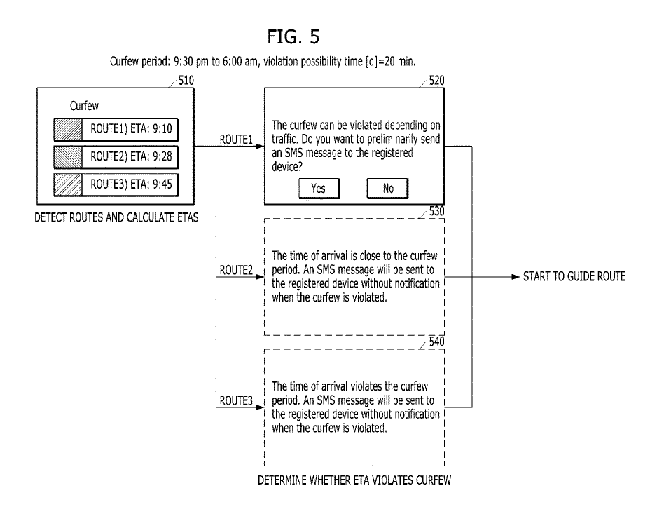

FIG. 5 is a flowchart related to an output interface of the curfew violation notification apparatus 100, according to another embodiment of the present invention.

Referring to FIG. 5, the output interface illustrated in FIG. 5 is substantially the same as the embodiment of FIG. 4 except for a few features.

In the embodiment of FIG. 5, a curfew period and a violation possibility time a may be preliminarily set, and a driver may select whether to send a warning message to the registered device 400, if an ETA violates the curfew period in consideration of the violation possibility time a.

A detailed description is now given of the violation possibility time a.

The violation possibility time a is a value preliminarily set together with the curfew period in the curfew violation notification apparatus 100 in order to consider a real-time traffic conditions. If a time obtained by adding the preset violation possibility time a to an ETA of a selected route is within a preset curfew period, a notification message may be sent to the preset device 400 based on driver selection.

For example, in consideration of a real-time traffic condition such as sudden traffic control or a serious traffic accident on the route to a destination, by determining whether a time obtained by adding the preset violation possibility time a to the ETA is within the curfew period, the driver may select whether to send a notification message and curfew violation information may be preliminarily given in this case, thereby preventing distraction.

In FIG. 5, the curfew period is preliminarily set to a period from, for example, 9:30 pm to 6:00 am, and the violation possibility time a is set to, for example, 20 minutes.

If the driver inputs a destination, the output module 120 of the curfew violation notification apparatus 100 may output an ETA of each of a plurality of detected routes using a display or a speaker (510) as in FIG. 4. In addition, operations performed when “route2” and “route3” are selected (530 and 540) are the same as those of FIG. 4.

However, if “route1” is selected (520), the ETA thereof is not within the curfew period but a time obtained by adding the preset violation possibility time a, i.e., 20 minutes, to the ETA is within the curfew period, a message such as “The curfew can be violated depending on traffic. Do you want to preliminarily send an SMS message to the registered device?” may be displayed. As such, the driver may select whether to preliminarily send a notification message to the registered device 400.

The effects of a curfew violation notification apparatus and method according to the present invention are described below.

First, according to the present invention, a driver may select a route based on an ETA of each of a plurality of routes, may individually determine whether the ETA of the selected route violates a curfew period, and may preliminarily recognize curfew violation before starting to drive. As such, sudden curfew violation notifications while driving may be effectively reduced, and the possibility of distraction may be effectively reduced.

Second, the possibility of safe driving may be increased and the possibility of traffic accidents may be reduced by preventing distraction of the driver.

Third, concomitantly, a vehicle may be prevented from being stolen by setting a curfew period and issuing a notification when the curfew period is violated.

It will be appreciated by persons skilled in the art that the effects that could be achieved through the present invention are not limited to what has been particularly described hereinabove and other advantages of the present invention will be more clearly understood from the above detailed description taken in conjunction with the accompanying drawings.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A curfew violation notification method comprising:
providing driver's destination to a navigation system of a vehicle;
detecting a plurality of routes from a current location of the vehicle to the destination;
calculating an estimated time of arrival (ETA) of each route;
determining whether the ETA of a first route selected among the plurality of routes is within a preset curfew period; and
sending a notification message to a setter's device if the ETA of the first route is within the curfew period,
wherein the driver is distinguishable from the setter.

2. The curfew violation notification method according to claim 1, wherein the plurality of routes from the current location of the vehicle to the destination are detected in consideration of real-time traffic information.

3. The curfew violation notification method according to claim 1, wherein the ETA of each route is calculated in consideration of real-time traffic information.

4. The curfew violation notification method according to claim 1, wherein the first route is selected based on the ETA and has the earliest ETA among the plurality of routes.

5. The curfew violation notification method according to claim 1, wherein the first route is selected based on the ETA and is selected among the plurality of routes by a driver.

6. The curfew violation notification method according to claim 1, wherein the notification message is sent to the setter's device through a short message service (SMS) or an e-mail.

7. The curfew violation notification method according to claim 1, wherein the notification message is sent to the setter's device based on driver's selection if a time obtained by adding a preset violation possibility time to the ETA of the first route is within a preset curfew period.

8. The curfew violation notification method according to claim 1, wherein sending the notification message to the setter's device is prior to starting the first route.

9. A curfew violation notification control apparatus comprising:
a driving route detection module for detecting a plurality of routes from a current location of a vehicle to a destination provided by a driver; and
an estimated time of arrival (ETA) calculation module for calculating an ETA of each route;
a curfew violation determination module for determining whether the ETA of a first route selected among the plurality of routes is within a preset curfew period; and
a communication module for sending a notification message to a setter's device if the ETA of the first route is within the curfew period,
wherein the driver is distinguishable from the setter.

10. The curfew violation notification control apparatus according to claim 9, wherein the driving route detection module considers real-time traffic information.

11. The curfew violation notification control apparatus according to claim 9, wherein the ETA calculation module considers real-time traffic information.

12. The curfew violation notification control apparatus according to claim 9, wherein the first route is selected based on the ETA and has the earliest ETA among the plurality of routes.

13. The curfew violation notification control apparatus according to claim 9, wherein the first route is selected based on the ETA and is selected among the plurality of routes by a driver.

14. The curfew violation notification control apparatus according to claim 9, wherein the communication module sends the notification message through a short message service (SMS) or an e-mail to the setter's device.

15. The curfew violation notification control apparatus according to claim 9, wherein the communication module sends the notification message to the setter's device based on driver selection if a time obtained by adding a preset violation possibility time to the ETA of the first route is within a preset curfew period.

16. The curfew violation notification control apparatus according to claim 9, wherein the communication module sends the notification message to the setter's device before the vehicle starts the first route.
